(19) United States
(12) Patent Application Publication
(10) Pub. No.: US 2026/0027925 A1
(43) Pub. Date: Jan. 29, 2026

(54) ELECTRIC VEHICLE CHARGER WITH HUMAN INTERFACE EQUIPPED COUPLER

(71) Applicant: Ampure Charging Systems, Inc., Monrovia, CA (US)

(72) Inventors: Matthew Zilmer, Monrovia, CA (US); Cooper Scannell, Monrovia, CA (US); Stephan Wagner, Monrovia, CA (US)

(21) Appl. No.: 18/780,876

(22) Filed: Jul. 23, 2024

(51) Int. Cl. B60L 53/18; B60L 53/16; B60L 53/30; B60L 53/62; H02J 7/00

(52) U.S. Cl. CPC B60L 53/18; B60L 53/16; B60L 53/305; B60L 53/62; H02J 7/00304; H02J 7/00309; H02J 7/0047; B60L 2250/16

(57) ABSTRACT

A charging system comprises a coupler configured to be coupled to an inlet of a vehicle and including a user interface, the user interface including a momentary switch mounted on the outer surface of the coupler and configured to receive a user input for an output current level selected by a user; and a light display mounted on the outer surface of the coupler and configured to illuminate a light to visually show the user selected output current level; and an in-cable control and protection device (ICCPD) disposed within a cable, the ICCPD configured to receive the user input from the momentary switch; determine an output current level that the charging system operates at, among the user selected output current level or a current limit level; and transmit back the user selected output current level to the coupler, wherein the vehicle is charged with the determined output current level.

### TECHNICAL FIELD

Embodiments relate generally to an electric vehicle charger, and more particularly to an electric vehicle charger including a user interface equipped coupler.

### BACKGROUND

An electric vehicle can be electronically charged through a charger. As the coupler and the plug of the charger are respectively connected to the inlet of the vehicle and an external power source, the power can be supplied from the external power source to the vehicle through this connection. In general, the output current level of the charging power can be only manually changed by switching between different chargers. For example, when the vehicle is charged through an alternating current (AC) charger, the user can only manually change between AC Level 1 and AC Level 2 by using the different grid cords, such as NEMA 14-50 for AC Level 2 and NEMA 5-15 for AC Level 1.

### SUMMARY

An embodiment of a charging system disclosed herein comprises a coupler configured to be coupled to an inlet of a vehicle and including a user interface, the user interface including: a momentary switch mounted on the outer surface, which may be a user-visible exposed, of the coupler and configured to receive a user input for an output current level selected by a user among a plurality of different output current levels; and a light display mounted on the outer surface of the coupler and configured to illuminate a light to visually show the user selected output current level; and an in-cable control and protection device (ICCPD) disposed within a cable connecting between the coupler and a plug, the ICCPD configured to: receive the user input from the momentary switch; determine an output current level that the charging system operates at, among the user selected output current level or a current limit level; and transmit back the user selected output current level to the coupler, where the vehicle may be charged with the determined output current level using the charging system.

An embodiment of a method for operating a charging system disclosed herein comprises forming at least one current limit level on an in-cable control and protection device (ICCPD) disposed within a cable; receiving a user input selecting an output current level by a user via a momentary switch mounted on an outer surface of a coupler; transmitting the user input to the ICCPD through a docking cable section of the cable, the docking cable section connecting between the coupler and the ICCPD; transmitting back an output for the user selected output current level to the coupler via the docking cable section; displaying a light according to the user selected output current level transmitted from the ICCPD by using a light display mounted on the outer surface of the coupler; determining the lowest requested current value among the at least one current limit level and the user selected output current level; and operating the charging system with the determined lowest requested current value.

A charging system embodiment may include: a coupler configured to be coupled to an inlet of a vehicle and including a user interface, the user interface including: a momentary switch mounted on the outer surface of the coupler and configured to receive a user input for an output current level selected by a user among a plurality of different output current levels; and a light display mounted on the outer surface of the coupler and configured to illuminate a light to visually show the user selected output current level; and an in-cable control and protection device (ICCPD) disposed within a cable connecting between the coupler and a plug, the ICCPD configured to: receive the user input from the momentary switch; determine an output current level that the charging system operates at, among the user selected output current level or a current limit level; and transmit back the user selected output current level to the coupler, where the vehicle may be charged with the determined output current level using the charging system.

In additional charging system embodiments, the momentary switch may be configured to select from the plurality of the different output current levels. In additional charging system embodiments, one of the plurality of different output current levels may be selected by pressing the momentary switch once each time. In additional charging system embodiments, the momentary switch and the light display of the user interface are disposed on a user-visible exposed surface of a handle portion of the coupler. In additional charging system embodiments, the momentary switch and the light display of the user interface are disposed on at least portions of a top surface and a side surface of a head portion of the coupler. In additional charging system embodiments, the momentary switch may be a dome switch.

In additional charging system embodiments, the light display illuminates a light according to a signal corresponding to the user selected output current level, where the signal may be transmitted back to the coupler from the ICCPD. In additional charging system embodiments, the user input from the momentary switch may be not directly transmitted to the light display without passing through the ICCPD. In additional charging system embodiments, the light display includes a plurality of light emitting diodes (LEDs), where the plurality of the LEDs correspond to the plurality of different output current levels, respectively, and only one of the plurality of the LEDs illuminates to visually show the user selected output current level. In additional charging system embodiments, the plurality of light emitting diodes (LEDs) have different light colors from each other and have the same output luminance.

In additional charging system embodiments, the current limit level includes a plurality of current limit levels, one of which may be to prevent an overtemperature condition of the charging system and another of which may be to prevent an overcurrent condition of the charging system according to an output current derating scheme of the ICCPD.

Additional charging system embodiments may further include: a temperature sensor that detects an internal temperature of the charging system and a current sensing circuit that detects an output current level of the charging system, where the ICCPD determines the output current level with the lowest current requested current value among: a primary input corresponding to the detected internal temperature; a secondary input corresponding to the detected output current level; and a tertiary input corresponding to the user selected output current level of the user input transmitted from the coupler.

In additional charging system embodiments, the light display may be configured to illuminate a light to visually show the user selected output current level corresponding to the tertiary input transmitted from the ICCPD regardless of the lowest current requested current value.

In additional charging system embodiments, the plurality of different output current levels that are selectable by the momentary switch are determined by a grid cord including the plug and a grid cable section of the cable, the grid cable section connecting between the ICCPD and the plug, and where the ICCPD identifies a type of the grid cord by cross referencing a data matrix.

A method for operating a charging system may include: forming at least one current limit level on an in-cable control and protection device (ICCPD) disposed within a cable; receiving a user input selecting an output current level by a user via a momentary switch mounted on an outer surface of a coupler; transmitting the user input to the ICCPD through a docking cable section of the cable, the docking cable section connecting between the coupler and the ICCPD; transmitting back an output for the user selected output current level to the coupler via the docking cable section; displaying a light according to the user selected output current level transmitted from the ICCPD by using a light display mounted on the outer surface of the coupler; determining the lowest requested current value among the at least one current limit level and the user selected output current level; and operating the charging system with the determined lowest requested current value.

In additional method embodiments, the step of forming at least one current limit level comprises: detecting an internal temperature of the charging system by using a temperature sensor; transmitting a primary input to the ICCPD corresponding the detected temperature; detecting an output current level of the charging system by using a current sensing circuit; and transmitting a secondary input to the ICCPD corresponding the detected output current level, where the at least one current limit level includes a plurality of current limit levels, one of which may be to prevent an overtemperature condition of the charging system and another of which may be to prevent an overcurrent condition of the charging system according to an output current derating scheme of the ICCPD.

In additional method embodiments, the steps of detecting the internal temperature, transmitting the primary input, detecting the output current level, and transmitting the secondary input are performed in parallel to each other and continuously monitored

In additional method embodiments, the user input transmitted to the ICCPD may be a tertiary input, where the step of determining the lowest requested current value may be performed to determine the lowest requested current value among the primary input, the secondary input, and the tertiary input.

In additional method embodiments, before the step of forming at least one current limit level, further comprising: identifying a type of a grid cord that includes a plug and a grid cable section of the cable, the grid cable section connecting between the ICCPD and the plug; and determining the current limit level corresponding to the type of the grid cord. In additional method embodiments, the user input from the momentary switch may be not directly transmitted to the light display without passing through the ICCPD.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 illustrates an electric vehicle charging system with a user interface equipped coupler, according to an embodiment of the disclosure herein;

FIG. 2 illustrates components of a user interface equipped coupler and an electric vehicle supply equipment (EVSE) of an electric vehicle charging system, according to an embodiment of the disclosure;

FIG. 3 illustrates a diagram of a user interface equipped coupler of an electric vehicle charging system, according to an embodiment of the disclosure;

FIG. 4 illustrates a flowchart for the operation of an electric vehicle charging system with a user interface equipped coupler, according to an embodiment of the disclosure; and

FIG. 5 illustrates a graph showing the output current derating scheme of an electric vehicle charging system with a user interface equipped coupler, according to an embodiment of the disclosure.

### DETAILED DESCRIPTION

The present disclosure provides an electric vehicle charging system including a user interface equipped coupler. The electric vehicle charging system with a user interface equipped coupler allows a user to control an output current level via a user interface on a coupler, thereby charging their electric vehicle with a user requested output current level. Through the user interface installed on the coupler, a user can easily control and select the output current level that the charging system operates at, seeing the visual representation of the user selected output current level, thereby providing user convenience and securing the manual current selectable function. In addition, since the output current level selected by a user input through the user interface is also controlled below the current limits by the microcontroller unit, the system can prevent overheating or overcurrent. Furthermore, regardless of the output current level determined for operating the charging system, since the output current level displayed on a light display of the user interface is a value that the user has selected, the user can check their selected output current level without any confusion via the display feedback. In this case, the system controls both a first output current level transmitted to display a light and a second output current level that the system operates at, by using one microcontroller unit. Thus, the system can prevent the possibility of syncing issues seen when two separate controllers make decisions.

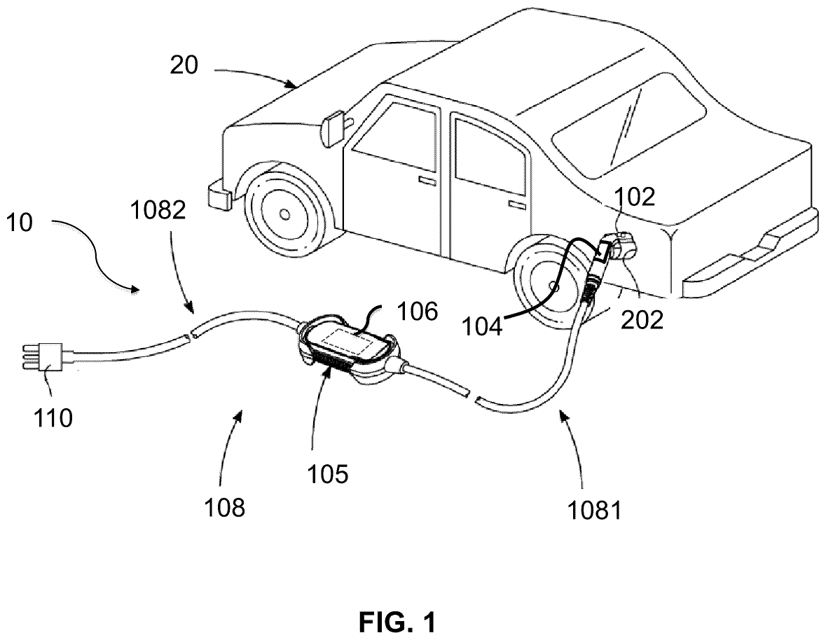

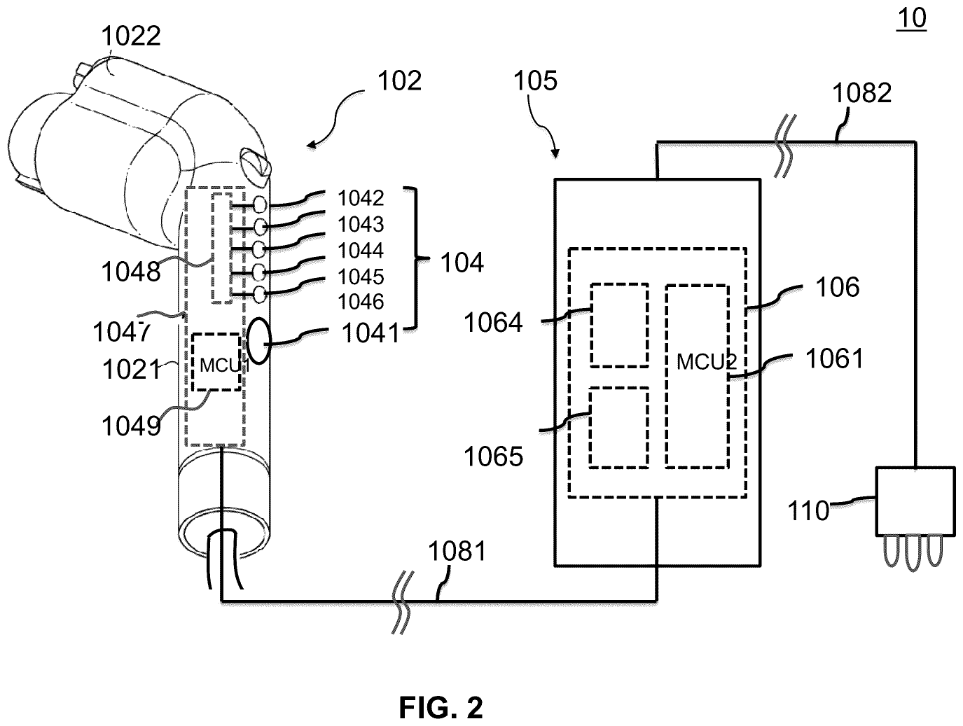

FIG. 1 schematically illustrates an electric vehicle charging system with a user interface equipped coupler, according to an embodiment of the disclosure herein. FIG. 2 illustrates components of a user interface equipped coupler and an electric vehicle supply equipment (EVSE) of an electric vehicle charging system, according to an embodiment of the disclosure. Referring to FIG. 1, a charging system 10 for an electric vehicle 20 may comprise: a coupler 102 including a user interface 104 on the outer surface of the coupler 102 and configured to be connected to an inlet 202 of the electric vehicle 20; an electric vehicle supply equipment (EVSE) 105 including an in-cable control and protection device (ICCPD) 106 and disposed within or incorporated into a cable 108; a plug 110 configured to connect between the cable 108 and an external power source; and the cable 108 configured to connect between the coupler 102 and the plug 110. The charging system 10 may be a portable charging system but is not limited thereto. In some embodiments, the charging system 10 may be installed at a fixed location. The cable 108 may be formed with the EVSE 105 and include a docking cable section 1081, which is positioned at one side of the EVSE 105 and connected to the coupler 102, and a grid cable section 1082, which is positioned at the other side of the EVSE 105 and connected to the plug 110. The set of the plug 110 and the grid cable section 1082 may be a grid cord, such as NEMA 5-15, NEMA 14-50, etc.

Specifically, referring to FIG. 2, the coupler 102 may include a handle portion 1021 and a vehicle interface portion 1022 that extends from the handle portion 1021 and is coupled to the inlet (202, FIG. 1) of the electric vehicle (20, FIG. 1). The handle portion 1021 may be provided to allow a user to easily grab the coupler 102 when coupling the vehicle interface portion 1022 of the coupler 102 to the electric vehicle (20, FIG. 1). In some embodiments, the user interface 104 may be formed on the top surface of the handle portion 1021 of the coupler 102 but is not limited thereto. In some embodiments, the user interface 104 may be formed on the top surface of the vehicle interface portion 1022. In another embodiments, a portion of the user interface 104 may be formed on the top surface of the vehicle interface portion 1022 and the remaining portion of the user interface 104 may be formed on the top surface of the handle portion 1021. In some embodiments, the user interface 104 may be formed on the side surface of at least one of the vehicle interface portion 1022 and the handle portion 1021.

The user interface 104 formed on the coupler 102 may allow the user to manually control and select the output current level without confusion, enabling the user to see the visual representation of the user selected output current level. The user interface 104 may include: a momentary switch 1041, through which a user can select an output current level; a light display, such as a plurality of light emitting diodes (LEDs) 1042, 1043, 1044, 1045, 1046, which visually shows the selected output current level with light; a first microcontroller unit 1049 configured to communicate with the user interface 104; and a first printed circuit board assembly (PCBA) 1047, to which each of the momentary switch 1041, the LEDs 1042 to 1046, and the first microcontroller unit 1049 are electrically connected.

In FIG. 2, the light display is illustrated as the plurality of light emitting diodes (LEDs) 1042, 1043, 1044, 1045, 1046, but the present disclosure is not limited thereto. The light display, which visually shows the selected output current level, may be any type of human machine interface (HMI) display, such as single and multi-segment LEDs, organic light-emitting diode (OLED) arrays, liquid-crystal display (LCD) panels, and others.

The momentary switch 1041 may be mounted on a user-visible exposed surface, or the outer surface, of the coupler 102 so that the user can conveniently put the thumb on and press the momentary switch 1041 to control the output current level. The user may switch the output current level by pressing this single momentary switch 1041 once each time. That is, the user may easily control the output current level from the very initial moment the user grabs the coupler 102 to any subsequent moments when inserting it to the electric vehicle (20, FIG. 1) or while charging is in progress. The plurality of LEDs 1042 to 1046 may also be mounted on the outer surface of the coupler 102 so that the user can visually recognize and confirm the output current level they select through the momentary switch 1041. The first PCBA 1047 may be disposed inside the coupler 102.

The momentary switch 1041 may be a contact switch, which requires continuous compression by the user to form a valid request for change in output current level. The momentary switch 1041 device type smooths user inputs and removes contact bounce. In some embodiments, the momentary switch 1041 may be a dome switch but is not limited thereto. The momentary switch 1041 may request different output current levels by multiple presses on the momentary switch 1041, holding for a certain time period, such as a few seconds, for each press. Depending on the type of the grid cord 110, 1082 used, i.e. NEMA 5-15 or NEMA 14-50, there may be a predetermined current selection from the user interface 104. That is, the output current levels may be discrete value sets determined by the system input voltage. There may be certain predetermined choices of output current levels depending on AC Level 1 (L1) or AC Level 2 (L2). For example, with a first voltage running the system 10, the output current level choices may be two, while with a second voltage different from the first voltage, the output current level choices may be three.

In some embodiments, the current selection may start at the highest current available, depending on the type of the grid cord 110, 1082 used. The user input using the momentary switch 1041 of the user interface 104 may lower the current rating from this highest available output current level. When the lowest available output current level is selected and the user presses the momentary switch 1041 again, the current selection may cycle back to the highest available output current level. In some embodiments, the system 10 may comprise a configuration that debounces the momentary switch 1041. With the debouncing configuration, contact bounce from the momentary switch 1041 may be removed.

The plurality of LEDs 1042 to 1046 may be respectively connected to individual LED drivers 1048 mounted on the first PCBA 1047 and configured to illuminate a light to display the user selected output current level. At any one moment, only one of the LEDs 1042 to 1046 may be lit up and directly indicate the user selected output current level. The LEDs 1042 to 1046 may emit different light colors from each other, such as red, orange, yellow, green, blue, respectively, according to the user selected output current level but may be tuned to the same output luminance. As mentioned above, the light display of the user interface 104 in FIG. 2 is illustrated as the plurality of LEDs 1042 to 1046, but the present disclosure is not limited thereto. In some embodiments, the plurality of LEDs 1042 to 1046 shown in FIG. 2 may be replaced with any type of HMI display, such as single and multi-segment LEDs, OLED arrays, LCD panels, and others.

The first microcontroller unit 1049, or MCU1, on the first PCBA 1047 may be electrically connected to the momentary switch 1041 and receive a user input through the momentary switch 1041. The user input transmitted through the momentary switch 1041 may indicate that a change in the output current level of an output for charging is being requested. Then, the first microcontroller unit 1049 may transmit this user input to a second microcontroller unit 1061, or MCU2, mounted on a second PCBA within the ICCPD 106 via a hardwire communication with the docking cable section 1081 of the cable 108. Even though both the momentary switch 1041 and the plurality of LEDs 1042 to 1046 are connected to the first microcontroller unit 1049 on the first PCBA 1047, the user input from the momentary switch 1041 may not be directly transmitted to the plurality of LEDs 1042 to 1046 without passing through the ICCPD 106. The user input transmitted to the ICCPD 106 may be used to determine outputs including a first output that may be utilized to operate the LEDs 1042 to 1046 to visually display the user selected output current level and a second output that may be used as the output current level that the charging system 10 operates at. The second output from the ICCPD 106 may be driven from the output current derating scheme to prevent overheating or overcurrent of the charging system 10. The first output within the ICCPD 106 may be then transmitted back to the first microcontroller unit 1049 and one of the LEDs 1042 to 1046 on the first PCBA 1047 to display a light to indicate the user selected output current level.

When the first output is received by the first microcontroller unit 1049, the first microcontroller unit 1049 may operate one or more LEDs among the LEDs 1042 to 1046 according to a read out of the first output, which corresponds to the user selected output current level of the user input. The illumination of a light using one or more of the LEDs 1042 to 1046 may visually display the user selected output current level to the user so that the user can confirm their selection for the output current level. Accordingly, this first output to the first microcontroller unit 1049 may always be the user selected output current level from the user input. Regardless of whether the user selected output current level is a current level that would cause overtemperature or overcurrent, the first output sent back to the coupler 102 from the ICCPD 106 for displaying may only be the user selected output current level, thereby preventing user confusion about light display feedback via the LEDs 1042 to 1046.

Meanwhile, the second output from the ICCPD 106 may be either the user selected output current level through the user input or a current limit, which is set in the ICCPD 106 to prevent overheating or overcurrent of the charging system 10. Thus, the second output may indicate the lowest output current level between the user selected output current level and the current limit, and this lowest output current level between the user selected output current level and the current limit may be used as the output current level that the charging system 10 operates at.

Specifically, the framework for the current control by the second microcontroller unit 1061 on the second PCBA within the ICCPD 106 may be the driven from the output current derating scheme. This output current derating scheme may have predetermined steps in which the second microcontroller unit 1061 of the ICCPD 106 may limit an output current level in case of overheating and/or overcurrent. Meanwhile, these predetermined steps may change based on the type of grid cord 110, 1082 being used, including a set of the plug 110 and the grid cable section 1082. In this case, the grid cord type may be identified by a grid plug process identification (GPPID). The GPPID may be any type of code that is permanently programmed and stored into each grid cord 110, 1082. This code may act as an identification of the grid cord type being used (i.e., NEMA 5-15, NEMA 14-50, etc.). In some embodiments, the code may be three digit numeric code but is not limited thereto. Any encoding may be used to identify the grid cord type.

The grid cable section 1082 may further comprise a plug sense line. The GPPID, the code of the grid cord 110, 1082 being used, may be sent to the second microcontroller unit 1061 of the ICCPD 106 via the plug sense line, and the second PCBA of the ICCPD 106 may cross reference a data matrix of codes and grid cord types, using the transmitted GPPID. The second microcontroller unit 1061 of the ICCPD 106 may convert this code into a corresponding grid cord type with specific current limitations, input voltages, ground type, and others, among many different grid cord types, by using this data matrix. This current limitation may then be set as the maximum current output of the charging system 10 using that grid cord 110, 1082 at a system level. Thus, the output current level that the charging system 10 operates at may be limited to this output current level. The second microcontroller unit 1061 of the ICCPD 106 may also choose the output current derating scheme paired with this grid cord type. A high-power output current derating scheme and a low-power output current derating scheme may be selected based on the grid cord 110, 1082 being used.

The EVSE 105 may further comprise one or more temperature sensors 1064 and current sensing circuits 1065. In this case, the temperature sensor 1064 may be assumed as a coupler temperature sensor. In some embodiments, the temperature sensors 1064 and/or current sensing circuits 1065 may be located within the ICCPD 1061 as shown in FIG. 2 but are not limited thereto. The one or more temperature sensors 1064 and current sensing circuits 1065 may be positioned at any locations of the system 10.

The output current derating scheme of the ICCPD 106 may be performed considering a temperature condition as a primary input, a current condition as a secondary input, and the user input as a tertiary input. The internal temperature value for the primary and internal current value for the secondary input may be continuously monitored. The internal temperature of the system 10 may be detected by the temperature sensor 1064, and the output current level of the system 10 may be detected by the current sensing circuits 1065.

Specifically, the primary input may be an internal temperature value, and in certain cases, the primary input may be an internal temperature value that exceeds the allowable temperature threshold. Likewise, the secondary input may be a detected output current level, and in certain cases, the secondary input may be a detected output current level that is above the maximum set current, or current limit, for a period of time.

The internal temperature value for the primary and internal current value for the secondary input may be continuously monitored, and at the same time, the primary and secondary input relevant to the monitored internal temperature value and the monitored internal current value may be requested from the second microcontroller unit 1061 of the ICCPD 106. That is, if the temperature sensor 1064 reads a temperature, the primary input relevant to the temperature condition may be requested from the second microcontroller unit 1061. If the temperature sensor 1064 reads a temperature above the temperature threshold, the primary input relevant to the overtemperature condition may be requested from the second microcontroller unit 1061. Likewise, if the current sensing circuits 1065 reads an output current level, the secondary input may be requested from the second microcontroller unit 1061. If the current sensing circuits 1065 reads an output current level above the maximum set current, or current limit, for a period of time, the secondary input relevant to the overcurrent condition may be requested from the second microcontroller unit 1061. These primary input and secondary input may be transmitted to the ICCPD 106.

In addition to these primary input and secondary input, the user input from the coupler 102 may also be added to the ICCPD 106 as the tertiary input for the output current derating scheme. The user input added as the tertiary input to the output current derating scheme may essentially allow a manual control to either step down or up the output current derating scheme. Specifically, the output current derating scheme of the ICCPD 106 may always determine as the maximum current limit for operating the charging system 10 the lowest requested current value across all three inputs of the primary input, the secondary input, and the tertiary input. Thus, the user selected output current level from the user input does not affect the ability of the ICCPD 106 to control an output current level to modulate temperature and/or protect itself and/or the electric vehicle (20, FIG. 1) from damage due to overtemperature. For example, if all conditions, temperature condition and current condition, are nominal and thus the primary and secondary inputs do not request a lower current value than the current value of the tertiary input, the output current level of the tertiary input may act as the second output for the operation of the charging system 10, and the user selected output current level may be the maximum current value that the charging system 10 will operate at. In the case of the output current derating scheme where there are overheating and/or overcurrent conditions, the “lowest bidder” amongst the three inputs may be the second output, and the corresponding current value may be the maximum current value that the charging system 10 will operate at.

Accordingly, the first output sent back to the first PCBA 1047 of the coupler 102 may then be displayed via the LEDs 1042 to 1046, and the second output may be used as an output current level for operating the charging system 10. As described above, the first output is always a tertiary input, which corresponds to the user input, and the second output is the lowest requested current value among the primary input, the secondary input, and the tertiary input.

As described above, the LEDs 1042 to 1046 is to show the user the output current level they have selected in an effort to not confuse the user with values they had not selected. The output current level displayed via the LEDs 1042 to 1046 will only be the value selected by the user, which corresponds to the tertiary input, and not the lowest requested current value across the three inputs. In other words, the user input may be transmitted to the ICCPD 106, then be sent back to the coupler 102 as the first output, and then be displayed to the user via the LEDs 1042 to 1046. That is, the LEDs 1042 to 1046 may be a direct read-out from the first output of the output current derating scheme in the ICCPD 106 and not tied directly to the user input within the coupler 102. The read-out for the LEDs 1042 to 1046 may always be aligned with the set output current level corresponding to the first output. The read-out is not the local selection from the user input via the momentary switch 1041 but rather a direct line of communication from the ICCPD 106. Accordingly, the LEDs 1042 to 1046 may read an actual output current level limited by the user through the first output and not by other requests for current limitations. In other words, the LEDs 1042 to 1046 display the backend current values, which indicate values corresponding to the tertiary input transmitted from the ICCPD 106 of the ESVE 105, and not the frontend current values, which indicate values that are directly tied to the user input from the user interface 104.

This process may allow the second microcontroller unit 1061 of the ICCPD 106 to do all of the computations for the operations of the charging system 10, preventing the possibility of syncing issues seen when two separate controllers, the first microcontroller unit 1049 and the second microcontroller unit 1061 on separate PCBAs, the first PCBA 1047 and the second PCBA of the ICCPD 106, try to make decisions. In addition, since the output current derating scheme of the ICCPD 106 may already define control functions for current limitations, tapping into that framework will allow the input signal to output a user selected maximum current, which then is displayed to the end user, eliminating the needs for additional functionality added to the ICCPD 106. If the additional functionality of the ICCPD 106 is required to implement the charging system 10, possible conflicts between the output current derating scheme and the addition would occur within the charging system 10 to regulate heat generation, protecting the system and the user from a thermal event.

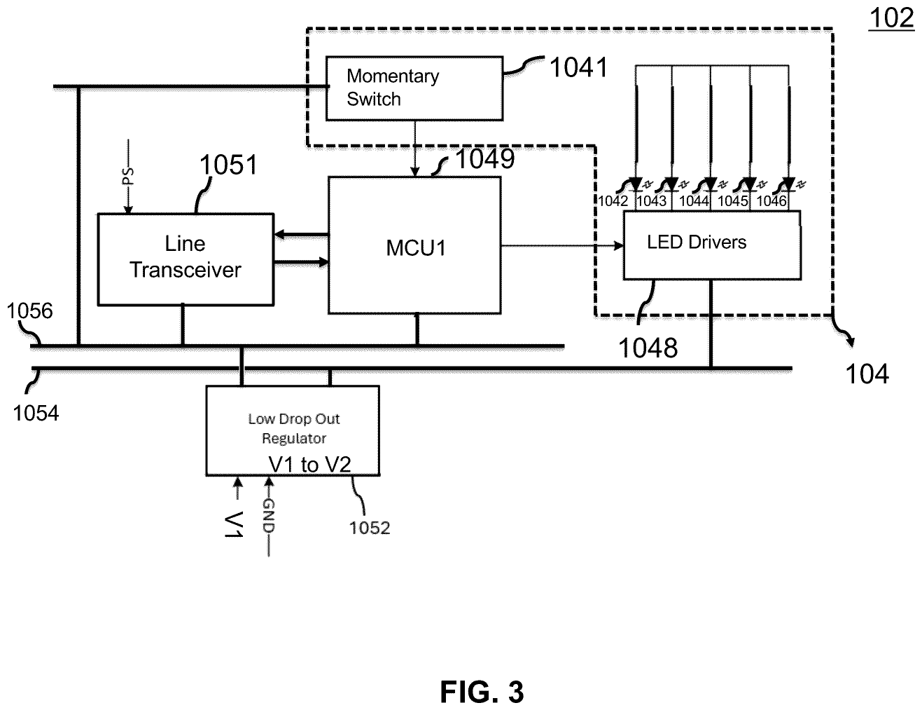

FIG. 3 schematically illustrates a diagram of circuit components of a user interface equipped coupler of an electric vehicle charging system, according to an embodiment of the disclosure. The circuit components of the user interface equipped coupler shown in FIG. 3 may correspond to components disposed on or inside the user interface equipped coupler 102 shown in FIGS. 1 and 2. Referring to FIG. 3, the coupler 102 may be equipped with the user interface 104, the first microcontroller unit 1049, a line transceiver 1051, and a low drop out (LDO) regulator 1052. As mentioned above, the user interface 104 may include the momentary switch 1041, the LEDs 1042 to 1046, and the LED drivers 1048. The user input from the momentary switch 1041 may be transmitted to the first microcontroller unit 1049 via the first PCBA (1047, FIG. 2) and then retransmitted or repeated to the second microcontroller unit (1061, FIG. 2) via the docking cable section (1081, FIGS. 1 and 2) and the second PCBA of the ICCPD (FIG. 2, 106). The first PCBA is omitted in FIG. 3. In addition, as described in FIG. 2, the signal for illuminating the LEDs 1042 to 1046 to show the user selected output current level may be transmitted from the second microcontroller unit (1061, FIG. 2) via the first microcontroller unit 1049. The signal for illuminating the LEDs 1042 to 1046 may not be directly transmitted from the momentary switch 1041. The momentary switch 1041 of the coupler 102 may include debounce circuits so that contact bounce from the momentary switch 1041 or other user inputs may be removed.

Each LED 1042 to 1046 may be connected to the individual LED drivers 1048, respectively, and may be tuned such that each of the LEDs 1042 to 1046 may form the same output illumination. As mentioned above, each of the LEDs 1042 to 1046 may be selected to emit different light colors from each other, such as red, orange, yellow, green, blue, respectively, according to the user selected output current level. The one or more of the LEDs 1042 to 1046 may be operated to illuminate according to the output from the second microcontroller unit 1061 via the corresponding individual LED driver 1048. As described above, the light display of the user interface 104 is illustrated as the plurality of LEDs 1042 to 1046 in FIG. 2, but the present disclosure is not limited thereto. The light display, which visually shows the selected output current level, may be any type of HMI display, such as single and multi-segment LEDs, OLED arrays, LCD panels, and others.

The line transceiver 1051 may be connected to the docking cable section (1081, FIGS. 1 and 2) and receive power supply PS from the ICCPD (106, FIG. 2) through the docking cable section (1081, FIGS. 1 and 2). Specifically, the power supply PS may be provided to the first PCBA (1047, FIG. 2) through the docking cable section (1081, FIGS. 1 and 2) and the second PCBA within the ICCPD (106, FIG. 2). The power supply PS used by the first PCBA (1047, FIG. 2) may be consistent regardless of grid cord (110, 1082, FIGS. 1 and 2). It may also does not have a relation with the GPPID.

In some embodiments, the electric vehicle charging system 10 may further comprise the low drop out (LDO) regulator 1052. The LDO regulator 1052 may regulate a higher voltage input to a lower voltage output at which the components of the coupler 102 operate. In this case, the LDO regulator 1052 may be configured to reduce voltage by a very small difference between the input V1 and output V2. Since the actual power supply voltage, the incoming voltage, may already be close to a requisite voltage used within the components of the coupler 102, the LDO regulator 1052, which regulates voltage by a small amount, may prevent voltage regulation failures.

Specifically, most voltage regulators require a substantial voltage drop from input to output to perform proper regulation. In some cases, when they fails to perform proper regulation, they may output OV due to a huge voltage drop, and no output voltage comes out. These regulation failures of most regulators occur especially when the incoming voltage is close to a requisite voltage within the circuit. On the other hand, since the LDO regulator 1052 of the present disclosure does not require a tremendous amount of voltage difference between input V1 and output V2 to perform a proper regulation, these regulation failures may not occur, and the coupler 102 may stably operate with the regulated output V2. For example, when the LDO regulator 1052 is supplied with 5V as an input voltage V1, the LDO regulator 1052 may regulate from the 5V input voltage V1 to 3.3V output voltage V2, which is only 1.7V voltage difference, whereas most regulators regulates voltage with at least approximately 2.4 volt difference and do not work well in the circuit like the coupler 102. In some embodiments, the input voltage V1 may be less than approximately 2V, and the LDO regulator 1052 may properly regulate this input voltage V1 by a small difference and provide a regulated output voltage V2 to the components of the couplers 102 without regulation failures. Accordingly, the LDO regulator 1052 may allow the components of the coupler 102 to obtain a current source at a requisite voltage without a huge voltage difference between input V1 and output V2 and regulation failures.

Most components of the coupler 102, including the first microcontroller unit 1049, the line transceiver 1051, and a momentary switch drive, may be driven by the output voltage V2 coming out of the LDO regulator 1052 through an output voltage bus 1056. The momentary switch drive may be a configuration that performs a button function, not a circuit in FIG. 3, and may be different from the button 1041 in the circuit of the coupler 102. Meanwhile, some components of the coupler 102 may be driven by the input voltage V1 through an input voltage bus 1054. These may include the LEDs 1042 to 1046, the LED drivers 1048, and the momentary switch 1041 that performs a switch function in the circuit in FIG. 3. For example, in the case where the LDO regulator 1052 regulates from 5V input voltage V1 to 3.3V output voltage V2, every components in the coupler 102 may be driven by 3.3V output voltage V2, except for the LEDs 1042 to 1046, the LED drivers 1048, and the momentary switch 1041, which may be driven by 5V input voltage V1.

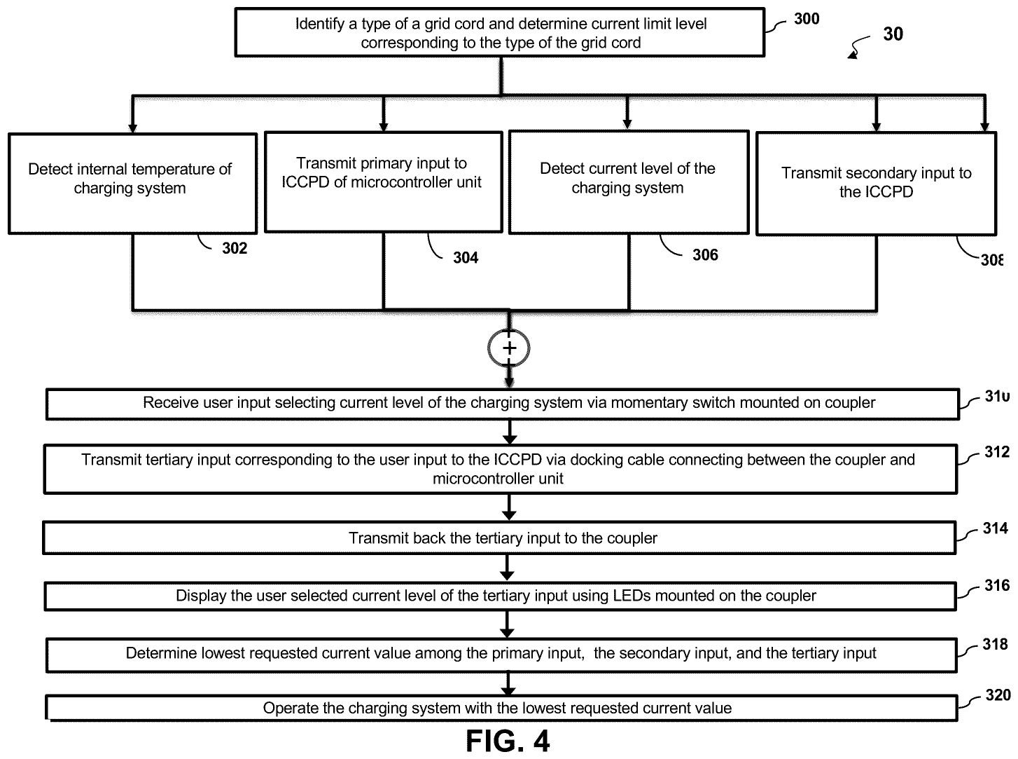

FIG. 4 illustrates a flowchart of a method for operating an electric vehicle charging system with a user interface equipped coupler, according to an embodiment of the disclosure. The method shown in FIG. 4 may be a method for operating the electric vehicle charging system 10 described in FIGS. 1 to 3. Referring to FIGS. 2 to 4, the line transceiver 1051 may identify a type of a grid cord connecting between the microcontroller unit 1061 and an external power source by using the GPPID and determine the current limit level corresponding to the type of the grid cord (step 300). The temperature sensor 1064 disposed in the ICCPD 106 may detect an internal temperature of the charging system, and a processor of the microcontroller unit 1061 may determine whether the detected temperature is overheating (step 302). If the processor of the microcontroller unit 1061 determines that the detected temperature is overheating, the processor may transmit a primary input to the microcontroller unit 1061 (step 304). Likewise, the current sensing circuits 1065 disposed in the ICCPD 106 may detect an output current level of the charging system, and a processor of the microcontroller unit 1061 may determine whether the detected output current level is overcurrent (step 306). If the processor of the microcontroller unit 1061 determines that the detected output current level is overcurrent, the processor may transmit a secondary input to the microcontroller unit 1061 (step 308). The steps 302 to 308 may perform continuously monitored functions that run concurrently with each other.

Meanwhile, the PCBA disposed in the coupler 102 may receive the user input selecting an output current level via the momentary switch 1041 mounted on the coupler 102 (step 310). Then, the PCBA may transmit the tertiary input corresponding to the user input to the ICCPD 106 through the cable 1081 connecting between the coupler 102 and the ICCPD 106 (step 312). The ICCPD 106 may then transmit back the tertiary input to the coupler 102 (step 314). The LEDs 1042 to 1046 mounted on the coupler 102 may display the user selected output current level of the tertiary input to visually show the user the output current level they have selected in an effort to not confuse the user with values they had not selected (step 316). The ICCPD 106 may determine the lowest requested current value among the primary input, the secondary input, and the tertiary input (step 318) to modulate the internal temperature and/or protect itself and the electric vehicle from overcurrent damage. At the same time, the charging system may operate with the lowest requested current value received from the ICCPD 106 (step 320).

The method 30 for operating the electric vehicle charging system with the user interface equipped coupler may enable the protection of the electric vehicle charging system without introducing additional components for processing the user input. Thus, the possible conflicts between the output current derating scheme and the additional components may be prevented. In addition, the method 30 may allow the ICCPD to do all the thinking, including the processes and determinations of the outputs for the charging system and the LEDs, and thus, the possibility of syncing issues, which may occur when two separate PCBAs try to make decisions, may be prevented.

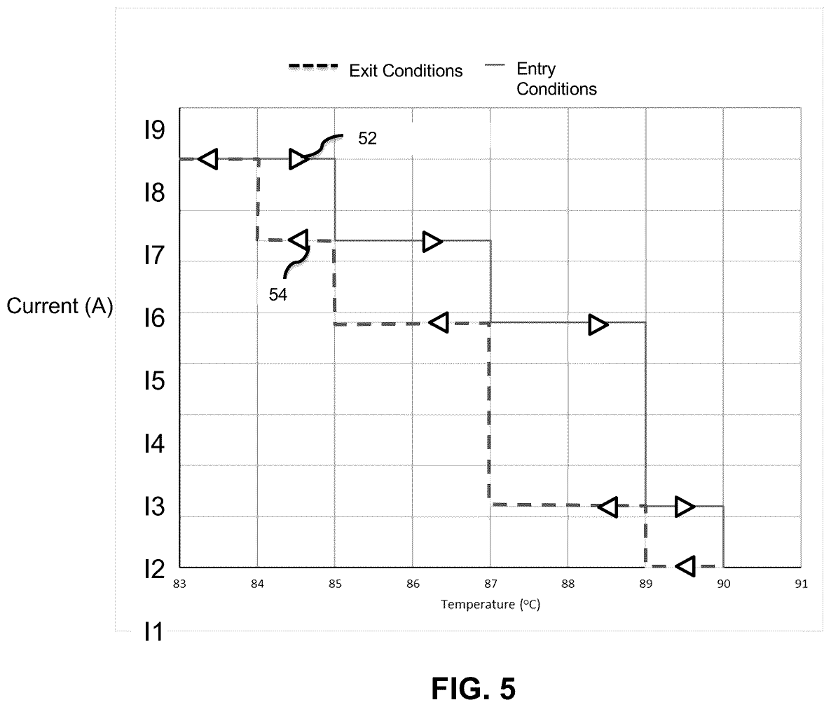

FIG. 5 illustrates a graph showing the output current derating scheme of an electric vehicle charging system with a user interface equipped coupler, according to an embodiment of the disclosure. The output current derating scheme of the ICCPD (106, FIGS. 1, 2, 3) may be a current limiting guide for the charging system (10, FIG. 1) to follow in the case of an overtemperature condition inside the ICCPD (106, FIGS. 1, 2, 3). This is depicted by the example graph shown in FIG. 5. Referring to FIG. 5, the charging system (10, FIG. 1) may follow this output current derating scheme to limit or reduce temperature generation within the ICCPD (106, FIGS. 1, 2, 3) by reducing the output current level. The steps on the output current derating scheme may directly correlate to the temperature seen by the internal temperature sensor (1064, FIGS. 2, 3) on the second PCBA of the ICCPD (106, FIGS. 1, 2, 3).

The solid line may represent entry conditions for the steps of the output current derating scheme, whereas the dashed line may represent exit conditions for the steps of the output current derating scheme. The exit conditions may be a little bit less than the entry conditions. The limiting current may be displayed on the y-axis (vertical), and the corresponding temperature may be displayed on the x-axis (horizontal). An arrow 52 on the entry conditions going up to the right indicates increasing temperature, and an arrow 54 on the exit conditions going down to the left indicates decreasing temperature. The combination of the arrow 52 on the entry conditions and arrow 54 on the exit conditions indicates the current control of the output current derating scheme of the ICCPD (106, FIGS. 1, 2, 3). For example, when the temperature goes up at the current value 18 and approach to 85° C., as indicated by the arrow 52 on the entry conditions, the output current level may be controlled to be lower than the current value 18 such that the temperature goes down to 84° C.

These arrows 52 and 54 may show the output current derating scheme's path. These two paths by the arrows 52 and 54 may be followed depending on whether the temperature is increasing, as indicated by the solid line, or decreasing, as indicated dashed line. These two paths by the arrows 52 and 54 may create a hysteresis relationship for the output current derating scheme, providing an “entry” and “exit” path for the output current derating scheme steps to prevent rapid oscillation between steps.

The output current level control function may use the steps of this output current derating scheme as a framework for selecting maximum current values via the user input. The output current derating scheme for the primary and secondary inputs may be a part of software logic of the ICCPD (106, FIGS. 1, 2, 3), and this output current derating scheme according to the present disclosure may be implemented by adding the tertiary input for the user selected output current level.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A charging system comprising:
a coupler configured to be coupled to an inlet of a vehicle and including a user interface, the user interface including:
a momentary switch mounted on the outer surface of the coupler and configured to receive a user input for an output current level selected by a user among a plurality of different output current levels; and
a light display mounted on the outer surface of the coupler and configured to illuminate a light to visually show the user selected output current level; and
an in-cable control and protection device (ICCPD) disposed within a cable connecting between the coupler and a plug, the ICCPD configured to:
receive the user input from the momentary switch;
determine an output current level that the charging system operates at, among the user selected output current level or a current limit level; and
transmit back the user selected output current level to the coupler,
wherein the vehicle is charged with the determined output current level using the charging system.

2. The charging system of claim 1, wherein the momentary switch is configured to select from the plurality of the different output current levels.

3. The charging system of claim 1, wherein one of the plurality of different output current levels is selected by pressing the momentary switch once each time.

4. The charging system of claim 1, wherein the momentary switch and the light display of the user interface are disposed on a user-visible exposed surface of a handle portion of the coupler.

5. The charging system of claim 1, wherein the momentary switch and the light display of the user interface are disposed on at least portions of a top surface and a side surface of a head portion of the coupler.

6. The charging system of claim 1, wherein the momentary switch is a dome switch.

7. The charging system of claim 1, wherein the light display illuminates a light according to a signal corresponding to the user selected output current level, wherein the signal is transmitted back to the coupler from the ICCPD.

8. The charging system of claim 1, wherein the user input from the momentary switch is not directly transmitted to the light display without passing through the ICCPD.

9. The charging system of claim 1, wherein the light display include a plurality of light emitting diodes (LEDs),
wherein the plurality of the LEDs correspond to the plurality of different output current levels, respectively, and only one of the plurality of the LEDs illuminates to visually show the user selected output current level.

10. The charging system of claim 1, wherein the plurality of light emitting diodes (LEDs) have different light colors from each other and have the same output luminance.

11. The charging system of claim 1, wherein the current limit level includes a plurality of current limit levels, one of which is to prevent an overtemperature condition of the charging system and another of which is to prevent an overcurrent condition of the charging system according to an output current derating scheme of the ICCPD.

12. The charging system of claim 1, further comprising a temperature sensor that detects an internal temperature of the charging system and a current sensing circuit that detects an output current level of the charging system,
wherein the ICCPD determines the output current level with the lowest current requested current value among:
a primary input corresponding to the detected internal temperature;
a secondary input corresponding to the detected output current level; and
a tertiary input corresponding to the user selected output current level of the user input transmitted from the coupler.

13. The charging system of claim 12, wherein the light display is configured to illuminate a light to visually show the user selected output current level corresponding to the tertiary input transmitted from the ICCPD regardless of the lowest current requested current value.

14. The charging system of claim 1,
wherein the plurality of different output current levels that are selectable by the momentary switch are determined by a grid cord including the plug and a grid cable section of the cable, the grid cable section connecting between the ICCPD and the plug, and
wherein the ICCPD identifies a type of the grid cord by cross referencing a data matrix.

15. A method for operating a charging system, the method comprising:
forming at least one current limit level on an in-cable control and protection device (ICCPD) disposed within a cable;
receiving a user input selecting an output current level by a user via a momentary switch mounted on an outer surface of a coupler;
transmitting the user input to the ICCPD through a docking cable section of the cable, the docking cable section connecting between the coupler and the ICCPD;
transmitting back an output for the user selected output current level to the coupler via the docking cable section;
displaying a light according to the user selected output current level transmitted from the ICCPD by using a light display mounted on the outer surface of the coupler;
determining the lowest requested current value among the at least one current limit level and the user selected output current level; and
operating the charging system with the determined lowest requested current value.

16. The method of claim 15, wherein the step of forming at least one current limit level comprises:
detecting an internal temperature of the charging system by using a temperature sensor;
transmitting a primary input to the ICCPD corresponding the detected temperature;
detecting an output current level of the charging system by using a current sensing circuit; and
transmitting a secondary input to the ICCPD corresponding the detected output current level,
wherein the at least one current limit level includes a plurality of current limit levels, one of which is to prevent an overtemperature condition of the charging system and another of which is to prevent an overcurrent condition of the charging system according to an output current derating scheme of the ICCPD.

17. The method of claim 16, wherein the steps of detecting the internal temperature, transmitting the primary input, detecting the output current level, and transmitting the secondary input are performed in parallel to each other and continuously monitored.

18. The method of claim 16, wherein the user input transmitted to the ICCPD is a tertiary input,
wherein the step of determining the lowest requested current value is performed to determine the lowest requested current value among the primary input, the secondary input, and the tertiary input.

19. The method of claim 15, before the step of forming at least one current limit level, further comprising:
identifying a type of a grid cord that includes a plug and a grid cable section of the cable, the grid cable section connecting between the ICCPD and the plug; and
determining the current limit level corresponding to the type of the grid cord.

20. The method of claim 15, wherein the user input from the momentary switch is not directly transmitted to the light display without passing through the ICCPD.
